(19) United States
(12) Patent Application Publication
(10) Pub. No.: US 2025/0211844 A1
(43) Pub. Date: Jun. 26, 2025

(54) VISUAL ANALYZER OF CONFINED PATHWAYS

(71) Applicant: UAM Tec Pty Ltd, Port Melbourne, Victoria (AU)

(72) Inventors: Alex Cutri, Port Melbourne, Victoria (AU); Shawn Taylor, Port Melbourne, Victoria (AU); Sugan Shrestha, Melbourne, Victoria (AU); Matthew Harrison, Melbourne, Victoria (AU); Sarmad Yousif, Port Melbourne, Victoria (AU)

(21) Appl. No.: 18/850,133

(22) PCT Filed: Mar. 24, 2023
(86) PCT No.: PCT/AU2023/050218

§ 371 Date: Sep. 24, 2024

(30) Foreign Application Priority Data
Mar. 25, 2022 (AU) 2022900761

(51) Int. Cl. H04N 23/50; G01S 17/86; H04N 7/18; H04N 23/56; H04N 23/661

(52) U.S. Cl. CPC H04N 23/555; G01S 17/86; H04N 7/181; H04N 23/56; H04N 23/661

(57) ABSTRACT

An automatic visual analyzer having a viewing body, a drive line being a tether, a control and communication system, and power input connected by the tether to the viewing body. The viewing body has a barrel section with a plurality of cameras mounted thereon in fixed related directions to allow a defined directional scan of the confined pathway. At a lower end of the barrel is a bell skirt which extends outwardly with a greater diameter than the barrel and the plurality of cameras so as to be the most outer part of the viewing body and provide protection from side engagements with the wall of the confined pathway.

### CROSS-REFERENCE TO RELATED APPLICATIONS

This application is a 371 National Phase Entry of International Patent Application No. PCT/AU2023/050218 filed on Mar. 24, 2023, which claims the benefit of Australian Provisional Patent Application No. 2022900761 filed on Mar. 25, 2022, the contents of which are incorporated herein by reference in their entirety.

### FIELD OF THE INVENTION

The present invention relates to an automatic visual analyzer and in particular to a remote controlled automatic visual analyzer.

The invention has been developed primarily for use in remotely analyzing confined pathways such as sewers and sewer access channels and will be described hereinafter with reference to this application. However, it will be appreciated that the invention is not limited to this particular field of use.

### BACKGROUND OF THE INVENTION

Investigation of confined pathways such as sewers and sewer access channels has primarily consisted of a person entering down a manhole and descending a ladder mounted on the inner wall. The main reason for undertaking this action is to determine the state of the confined pathway, the integrity of the walls, and whether there is any foreign material or other obstruction within the confined pathway.

Therefore, people are being sent down into unknown environments with unknown safety. The ladder could have rusted and readily collapse. The walls could be crumbling, and therefore the ladder breaks away from the wall with the weight of the user. There could be hazardous environment or unsafe restrictions in the confined pathway that cause entrapment or injury.

A light could be lowered into the confined pathway and the lit up inner surface reviewed from above. However, this is limited in effectiveness and depth, and often there is a lack of perspective of depth. Further the viewer must dangerously overhang the top opening of the confined pathway which could result in slippage or cause the opening to give way and cause debris to fall down on the light.

A substantial limitation is that the supply of power is limited and any damage or contact with water can cause failure of the light or possibility of electrocution to the operator.

A camera could be lowered into the confined space, but it is even more delicate than a light. Further control of a dangling camera is likely to swing into the walls of the confined pathway and cause entanglement on crevices or other protrusions or damage by contact.

Further it is generally required that the camera needs to work without a light or be low resolution.

Still further due to any pendulum effect it is not known what the location is of what can be seen by any suspended camera. When more than 10 meters down, a small suspension angle deviation angle at the top will effect a large lateral deviation below. This will increase at depth increases. Therefore, it is not known if you are close to the wall or if the confined space has widened or narrowed. Substantial important information is not known. Therefore, the confined pathway remains an unknown danger risk or status risk.

Overall, these limitations mean that the requirement for repair, deblocking, flushing, or other treatment cannot be determined.

A lot of these problems are amplified when any camera engages water. The same operation at the top of the confined pathway will cause a different effect in the water at a lower position in the confined pathway. For example, the pendulum effect will have a damper element due to the drag of the water. This even further reduces the chance of interpreting what is visible by the camera and where it is.

A functional limitation is that copper wire is the usual usage for power and for data transfer. This severely limits any capability and therefore deep confined spaces cannot be viewed clearly, and even shorter confined spaces cannot carry high resolution.

It can be seen that the known prior art has the problems of:
(a) it is unknown what type of dangerous environment is present;
(b) it places operators at risk;
(c) it is not possible to survey deep confined pathway in detail;
(d) it is not possible to coordinate camera, lighting, and power for deep confined pathway;
(e) limitations of camera, lighting, and power means it is not possible to undertake high definition;
(f) there is no knowledge of clearly determining what is viewable or where it is viewable; and/or
(g) there is no capability of use of high definition in deep and multifluid confined pathways.

The present invention seeks to provide an automatic visual analyzer, which will overcome or substantially ameliorate at least one or more of the deficiencies of the prior art or to at least provide an alternative.

It is to be understood that, if any prior art information is referred to herein, such reference does not constitute an admission that the information forms part of the common general knowledge in the art in Australia or any other country.

### SUMMARY OF THE INVENTION

According to a first aspect of the present invention, there is provided an automatic visual analyzer for remotely analyzing confined pathways such as sewers and sewer access channels, the automatic visual analyzer comprising a viewing body having a plurality of cameras mounted thereon in fixed related directions to allow a defined directional scan of the confined pathway; a drive line for providing a directional path along the confined pathway by which the viewing body can be driven, at least one communication system connected to the body and/or drive line for control communication of the viewing body and communication with the plurality of cameras, and at least one controller for transmitting or receiving communication from the at least one communication system allowing the communication to be transmitted or received external of the confined pathways being analyzed.

The automatic visual analyzer can include a 3D generator for generating a digital representation of the confined pathway by the overlap known directional scans by the plurality of cameras mounted on the viewing body in fixed related directions.

The confined pathway is substantially in the range of 0.5 meters to 5 meters. The depth can be 60 meters.

The drive line preferably is a tether for a vertical gravity driven feed. This drive line can be wound in a depth spool for release of controlled lengths of tether to alter the depth of the viewing body on the tether and further includes a depth spool controller for controlling the release of the controlled lengths of tether.

The drive line can include a stabilizer for stabilizing the released controlled lengths of tether to stabilize the orientation of the tether and the viewing body. The stabilizer in one form includes a momentum wheel damper unit for damping the vertical torques (or swing) generated on the viewing body due to the pendulum-like nature of the entire unit. This momentum wheel damper unit can include a flywheel spun up to roughly 3,000+ RPM by a brushless DC motor (BLDC), allowing rotation in the x- and y-plane by servo motors to impart reaction torques on the body for damping the vertical torques (or swing) generated on the viewing body due to the pendulum-like nature of the entire unit.

The plurality of cameras is mounted on the viewing body in fixed related directions and is mounted coplanar in a direction normal to the directional path of the driveline. The number of the plurality of cameras is dependent on the relative location and the coplanar field of view (HFOV) of the lens of the plurality of cameras.

Each of the number of the plurality of cameras have a related light mounted adjacent on the viewing body. Preferably the mount of each related light mounted adjacent on the viewing body includes an adjustable means allowing the camera and light to substantially align with the camera line of sight. The mount can include an adjustable bracket allowing the camera and light to substantially prealign to intersect the camera's line of sight at the required focus distance in the confined pathway.

The required focus distance in the confined pathway is related to the diametrical dimension of the wall of the confined pathway.

The automatic visual analyzer can include a combination of a pressure sensor and a single point LiDAR in the directional path of the drive line which can be used to accurately tag the video feeds/images of the plurality of cameras and the true position within the confined pathway.

The invention also provides a method of visual analysis of confined pathways such as sewers and sewer access channels including the steps of:
(a) providing a viewing body having a plurality of cameras mounted thereon in fixed related directions to allow a defined directional scan of the confined pathway automatic visual analyzer;
(b) feeding the viewing body along a directional path in the confined pathway;
(c) coordinating the plurality of cameras and respective lights to focus at required focus length through a triangulation of direction of camera to respective light; and
(d) Coordinating other sensors with the cameras to provide a scanned image of confined pathway at known location.

The method can include using LiDARs in parallel coordination with the plurality of cameras to allow a coordinated overlap of the scanned images from the camera and the LiDARs.

Preferably the method includes using coordinated focus of cameras and respective lighting by a triangulated directional mounting of each camera and its respective light.

The power to the viewing body having a plurality of cameras can be by a staged power supply and allowing operation of the viewing body having a plurality of cameras at low voltage.

To control pendulum sway, the method can include a stabilizer for stabilizing the released controlled lengths of tether to stabilize the orientation of the tether and the viewing body. The stabilizer in one form can include a momentum wheel damper unit for damping the vertical torques (or swing) generated on the viewing body due to the pendulum-like nature of the entire unit.

Other aspects of the invention are also disclosed.

### BRIEF DESCRIPTION OF THE FIGURES

Notwithstanding any other forms which may fall within the scope of the present invention, a preferred embodiment of the invention will now be described, by way of example only, with reference to the accompanying drawings in which:

FIG. 1 is a diagrammatic overview of an automatic visual analyzer for remotely analyzing confined pathways such as sewers and sewer access channels in accordance with a preferred embodiment of the present invention;

FIG. 2 is a diagrammatic side view of a viewing body of the automatic visual analyzer of FIG. 1;

FIG. 3 is a diagrammatic underneath perspective view of the viewing body of the automatic visual analyzer of FIG. 1;

FIG. 4 is a diagrammatic exploded view of the viewing body of the automatic visual analyzer of FIG. 1;

FIGS. 5, 6, and 7 are functional box diagrams of the components of an embodiment of an automatic visual analyzer such as in FIG. 1 showing the manhole unit (confined pathway unit), surface control unit (controller) and detail of the momentum wheel damper unit of FIG. 5;

FIG. 8 is a diagrammatic view of a method of visual analysis of confined pathways such as sewers and sewer access channels in accordance with a preferred embodiment of the present invention;

FIGS. 9, 10, and 11 are diagrammatic views of a complete view, an exploded view, and a detail view of an embodiment of a momentum wheel damper unit in the form of a stabilizer (81) which uses control moment gyroscope to generate a momentum vector with direction control;

FIG. 12 is a diagrammatic view of a further form of the automatic visual analyzer showing its modularity with attachability of other cameras;

FIG. 13 is a further exploded diagrammatic view of a still further form of automatic visual analyzer showing its modularity and attachability of other working modules such as arms with working claws; and

FIG. 14 is a diagrammatic view of the detail of the visual analyzer in location in a manhole having consistent spacing of lights, camera, and LiDAR to effect the triangulation field of view (FOV) and focus to allow the 3D imaging and location of image in confined spaces.

### DETAILED DESCRIPTION OF SPECIFIC EMBODIMENTS

It should be noted in the following description that like or the same reference numerals in different embodiments denote the same or similar features.

Referring to the drawings, there is shown one form the invention which provides an automatic visual analyzer (11) for remotely analyzing confined pathways (15) such as sewers and sewer access channels.

The automatic visual analyzer (11) comprises a viewing body (21), a drive line (24) being a tether, a control and communication system (62), and power input (63) connected by the tether to the viewing body (21).

The viewing body (21) has a barrel section (22) with a plurality of cameras (31) mounted thereon in fixed related directions to allow a defined directional scan of the confined pathway. At a lower end of the barrel (22) is a bell skirt (23) which extends outwardly with a greater diameter than the barrel (22) and the plurality of cameras (31) so as to be the most outer part of the viewing body (21) and provide protection from side engagements with the wall of the confined pathway (15).

The drive line (24) in one form is a tether for providing a vertical directional path along the confined pathway (15) by which the viewing body (21) can be driven by gravity.

The communication system is connected to the viewing body (21) by the drive line (24) for control communication of the viewing body and communication with the plurality of cameras. At least one controller for transmitting or receiving communication from the at least one communication system allows the communication to be transmitted or received externally from the confined pathways being analyzed.

### Camera System

Cameras (31) can be 180° view cameras. The objective of camera (31) placement is to make sure that the area of focus is a short distance such as 2 meters from the camera. This is to ensure the best quality image is captured. Although focus on 0.5 meter to 2 meters is planned the cameras will capture objects that are further away than 2 meters such as up to 5 meters.

The benefit of the use of a monoscopic camera is that it can be digitally controlled and provide a wide-angle image such as a 180° hemispherical view. Further the images can be more readily digitally knitted together. This is particularly beneficial in providing a panoramic view at a predetermined focused distance or at a predetermined focusing time.

However, cameras to be used can be “wide-angle” to the extent that they cover 90° to 180°. This will provide an outward hemispherical viewing angle so that the cameras can sit flat on the body of the submersible and look along the body as well as outwardly. Therefore, the camera is proud of the surface of the body but the degree of proudness is limited so as to avoid overly affecting the aerodynamics and contact points of the body. The cameras therefore extend within the footprint of the bell skirt of the body such that the skirt minimizes any contact with the cameras.

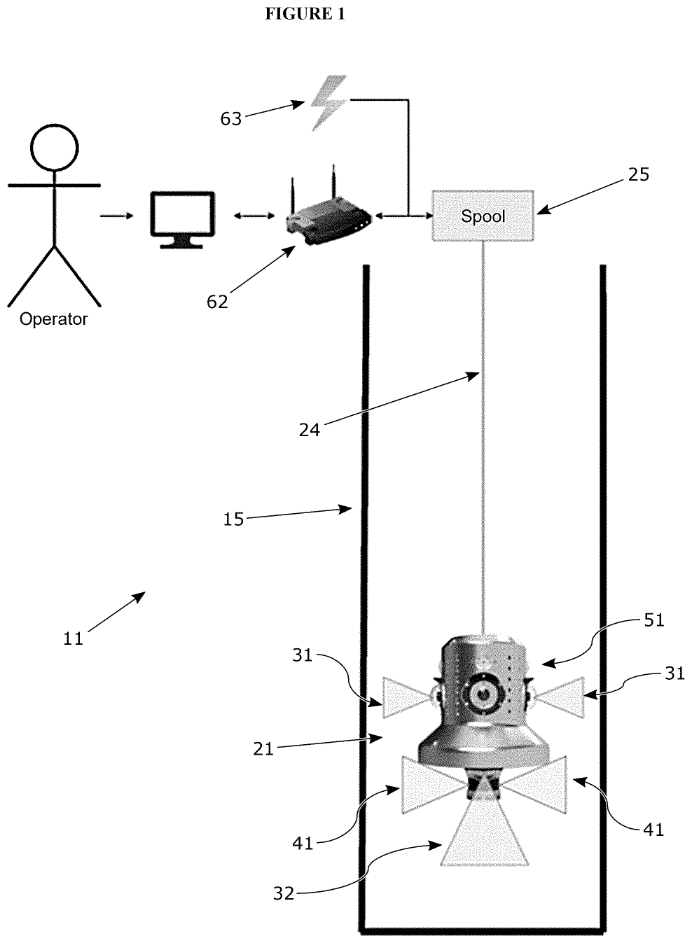

Referring to FIG. 1 there are shown monoscopic wide-angle cameras (31). The camera (31) is mounted in respective covering optically transparent dome body and arranged for viewing throughout the entire 180° view. Each camera is located at the same diametric planar cross section at an angular 90° to each relative to the central axis of the barrel of the viewing body. This ensures scanned viewing of a complete 360° view from only a short distance from the outer surface of the barrel (22).

There can be at least one optical device controller connector for controlling particular input of the plurality of cameras for upload to a computerized means so that there can be operational control of the cameras.

Cameras are located in two main locations. The main cameras (31) are mounted in the planar arrangement around the barrel (22) of the body and normal to axis of the barrel. The second location is on the underneath part of the bell skirt and facing inline to direction of travel along directional path provided by the tether (24). This camera is therefore an inline camera (32).

The spacing of the cameras (31) around the barrel circumference is dependent on the diameter of the circumference and the tangential effect of the 180° cameras. It is needed to minimize “optical dead spots” by ensuring the tangential line of one camera to the other.

In the disclosed embodiment there are 4× standard wide-angle lens cameras (4 k UHD), positioned at 90° increments around the body of the viewing body. This produces “360°” vision of the entirety of a manhole environment, with good overlap between each camera allowing for postprocess stitching of the images (image mosaic creation).

The horizontal field of view (HFOV) of the lens should be proportional to the diameter of the manhole that you are working in. Smaller manholes require larger HFOV, in order to still achieve satisfactory overlap between cameras. The wide angle also allows an operator to view underneath ledges.

The 1× bottom inline camera (32) is a wide-angle 4K camera. This camera captures the detail in the bottom-facing “inline” direction, to allow an operator to observe obstacles in the tunnel or see the manhole bottom.

By having the cameras aligned in linear circumferential arrangement there is a physical fixed relationship between the cameras. To take advantage of this linear alignment it is also necessary to obtain time alignment or synchronicity.

Synchronicity can be achieved by the method of providing a location fixed relative location of a plurality of cameras. This is particularly provided by the circumferential array of cameras (31) on the barrel (22) of the viewing body (21). However, if the operation of the cameras is not coordinated then each camera on the viewing body will be scanning at a different location than when the other cameras were operated. This would effectively be like having a random location of cameras (31) on the viewing body (21).

It is therefore important to have synchronicity of operation of cameras (31). This cannot be achieved simply by logic switches as there is too great a variation of operation due to the physical limitations of electronic switching.

In operation there is the providing of control signal operation to each of the location fixed relative locations of a plurality of cameras and then each camera separately upon receipt of control signal checking with global clock. In the provided control signal operation, a time control point will be predefined.

Each camera can separately undertake the control action at the next predetermined particular time control point and results in images are provided that are with a fixed relative location and with a fixed relative synchronized time and thereby in allowing knitting of images with a fixed relative location and with a substantially relative synchronized time.

As all cameras (31) are not acting based on the time they are control instructed but instead on a particular control time point. Therefore, if there is an inherent relay delay to a camera it is not affected as long as the time control point is larger than the delay and as long as each camera control is connected to the global clock. In this way synchronicity is within a ±4 millisecond variation.

This results in the knitting of images of the scans provided by the relatively located and simultaneously time operated control of the outwardly viewing multiple cameras (31) in the planar cross-sectional arrangement of the barrel of the viewing body (21). In particular this can allow for providing a localized panorama formed by the optical cameras locating an object or the lack of an object in a predefined focused distance from the viewing body and allowing the localized panorama for use in creating an interlinked panorama by the network of cameras.

A navigation system can be provided by this relativized panorama formed by the optical cameras locating an object or the lack of an object in a predefined focused distance from the elongated body and within a calculated time and or distance from the viewing body locating an object or the lack of an object in a predefined focused distance from the elongated body allowing the localized panorama.

### Housing

A housing is designed to be robust and rugged in the hazardous environments expected to be encountered within the manhole or vertical shaft. The main hull of the visual analyzer is fully sealed, such that there is no transfer of fluid or gas between the visual analyzer housing and the environment.

In one form the housing comprises the following:
(a) Anodized aluminum or other corrosion resistant material is used to ensure robustness in the environments listed.
(b) A ported pressure sensor is used, which allows the main hull of the visual analyzer to remain fully sealed while also allowing the detection of ambient pressure (and therefore depth). The diaphragm of the sensor is exposed, without exposing the internals.
(c) All penetrations are potted, or sealed by O-ring or other means, to ensure no transfer of fluid/gas between internal and external.

### Lighting System

For cameras (31) to operate they require controlled lighting. This control must be a control of direction and intensity and avoid interference with the ability of the cameras (31) to scan images without interfering dispersed light. One each of a plurality of LEDs (51) is relatively in line with each camera (31) to ensure illumination of the subject that the respective camera is viewing.

The lights are angled so that there is a triangulation of the focus of the light intersecting with the focus of the camera at the required distance from the viewing body. This provides the benefit that the camera is operating in coordination with its respective light.

In a physical location of each camera (31) and its respective LED light (51) there must in reality be a spacing on the barrel (22) of the viewing body. Therefore, this angularity provides the benefit that the camera can operate in the central prime emanation of the light and not in a variable unknown fringe of the emanated light.

The lights can be adjustable so that the mount includes an adjustable bracket allowing the camera and light to substantially align with the camera's line of sight. This allows the adjustment to be done prior to deployment. Preferably the adjustable bracket of the mount allows an adjustment up to 20° left-to-right and can allow an adjustment up to 30° in elevation. Therefore, the mount adjustable bracket allows the camera and light to substantially prealigned with the user's line of sight to a required focus distance in the water.

The LEDs (51) are also adjustable in brightness to adapt to different lighting conditions in the confined space or different fluid media such as a transition from air to water in a sewer.

### 360 Point Cloud

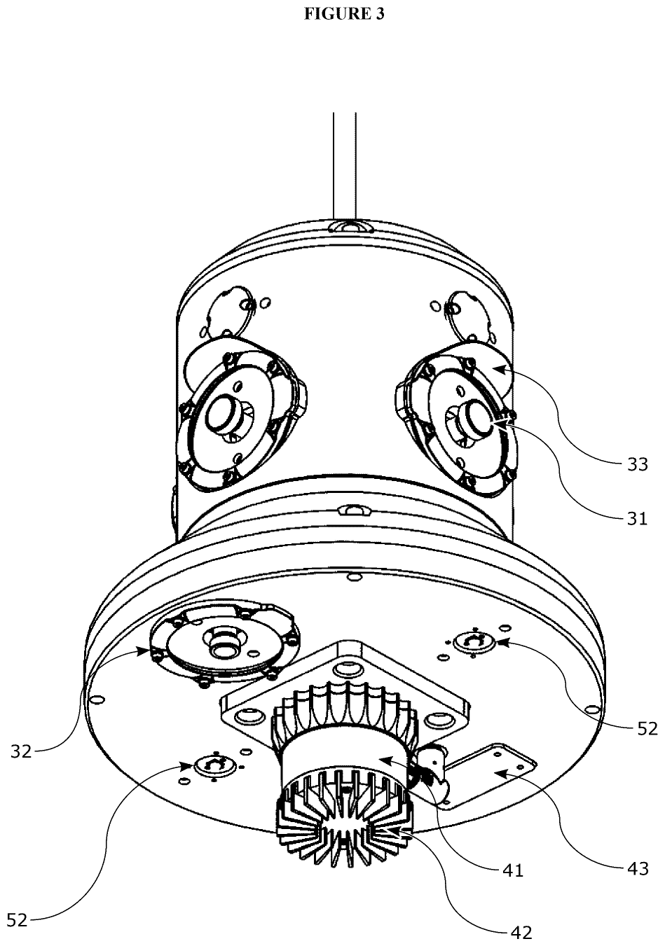

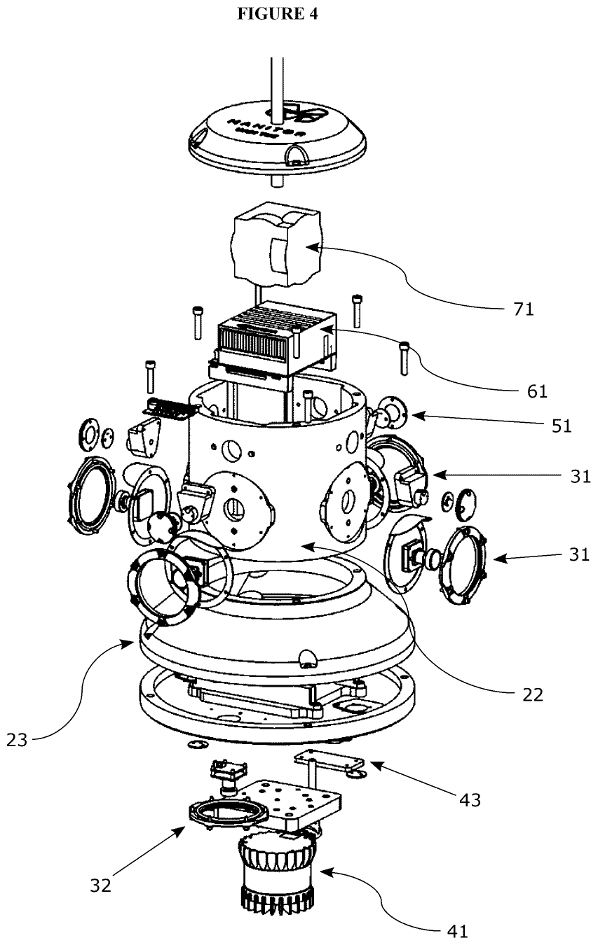

As well as visual image cameras (31) the viewing body includes other light viewing technologies including LiDAR, being a remote sensing method that uses light in the form of a pulsed laser to measure ranges. As shown in FIGS. 3 and 4 the viewing body includes two types of LiDAR: a 360° LiDAR (41) and a single point LiDAR (43).

The 360° LiDAR (43) is mounted coaxially with the axis of the barrel (22) of the viewing body (21) so that it provides a 360° view since it is mounted underneath the bell skirt (23) of the viewing body the 360° LiDAR and the plurality of cameras (31) are operating in parallel planes but will not interfere with each other due to the shadow of the bell skirt. Therefore, an interaction of the data from each of these sources strengthens accuracy and eliminates discrepancies.

The 360° LiDAR can be used to generate a 3D digital representation of the manhole, which can then be underlaid on the 360° camera feeds. The combination of visual image and point cloud can help to provide greater detail of tunnel features while also maintaining context of the scene because of the overlaid images.

The single point LiDAR being a downward facing LiDAR forms an inline LiDAR (43) that operates in the directional path provided by the drive line of the tether (24). This single point LiDAR can be used in synergistic combination with the inline camera (32) and other sensors.

### Power Supply

Streaming over distances between the remote-control location above ground and the viewing body (21) tethered is achieved by use of fiber optic cabling. This allows the length of operation to be extended far beyond anything available to traditional copper methods. However, that distance therefore creates problems that need to be overcome. This includes the dramatic loss of power of distances, the functionality, and the importance in not hindering use in an already confined pathway below the surface.

The power supply needs to operate in the tether together with the transfer of controls and the transfer of scanned viewed imagery. The electronics collects the data from the visual image capture and is connectable by connection (12) to transfer the data to an operator computer or remote station (11).

Multiple power supplies are used: 48 V to 12 V step-down and 48 V to other low voltage step-down inside splitter box in the viewing body to various elements operating in the viewing body.

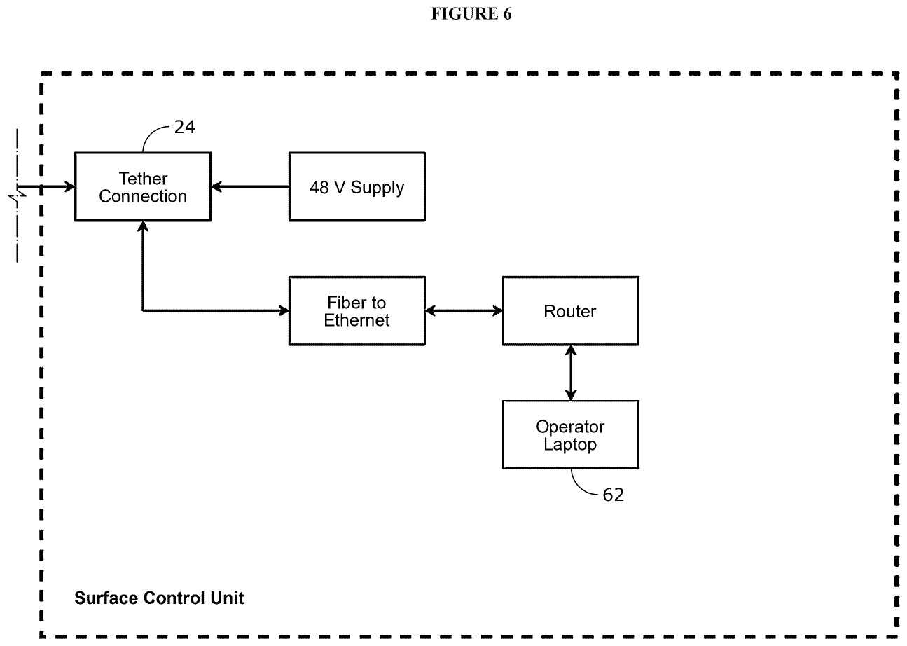

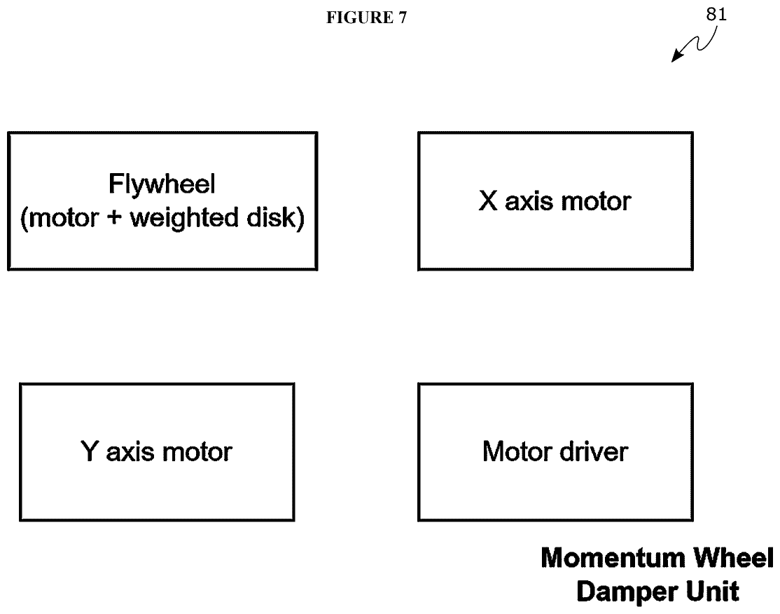

As shown in FIGS. 6 and 7, the power system (14) for allowing the controllable use of the camera system mounted on the viewing body is connected by power line in the tether (12) to the tether spool connector to the above ground power supply.

### Hybrid Tether

The hybrid tether used is an OM3 multimode fiber optic cable (2 cores), allowing for very high data throughput (10 Gbit) over extended distances (300 m), greater than that offered by traditional copper-based solutions.

The fiber cable carries data (commands sent from surface to viewing body, video and sensor feeds, and any other comms) from the surface computer to the viewing body unit. Ethernet to fiber converter on surface carries the ethernet protocol data over fiber to the viewing body, where it is converted back into ethernet via a fiber to ethernet converter. This connects into the viewing body onboard computer and 360° LiDAR in a local network configuration.

2-core 12 AWG copper cable is used to carry 48 V DC from the surface down to the viewing body unit to power the various power supplies that step down the voltage for each respective subsystem of the unit.

### Surface Spool

The surface spool (25) holds the entirety of the hybrid tether (24) and allows for easy deployment of the unit in the field. The tether spool (25) has ethernet and power connectors on the outside, which are fixed in the center of the spool. 48V comes into the spool, goes through a built-in slip ring and then feeds through the hybrid tether. The Ethernet cable also goes through slip ring and into an ethernet to fiber converter, which then feeds into the same hybrid tether from above (as fiber optic cable).

The slip ring mentioned above allows the spool and tether to rotate freely, without tangling the rest of the cables that are attached from the surface (Ethernet and power). Hence, this slip ring is a critical aspect in allowing the efficient operation of the viewing body unit.

In one form, controlled deployment via automated tether spooling system and sensor feedback has the following:
(a) Automated tether deployment (i.e., digital spool driven by motor) is important because any human intervention (e.g., manual lowering of the visual analyzer) could introduce disturbance, which would thus cause swing and twist of the unit.
(b) Sensor feedback (from sensors like atmospheric pressure, range-to-bottom LiDAR, inertial measurement units [IMU], cable counter) allows the system to automatically adjust for detected swing, twist, and account/counteract it by manipulation of the momentum wheel inside the visual analyzer unit or spooling speed of the digital spool.
(c) The unit must be lowered consistently in order to prevent sudden changes in acceleration/jerk, which would introduce swing. At larger depths, this is exacerbated, as the system acts like a heavy weight on a pendulum string.

### Momentum Wheel Damper Unit

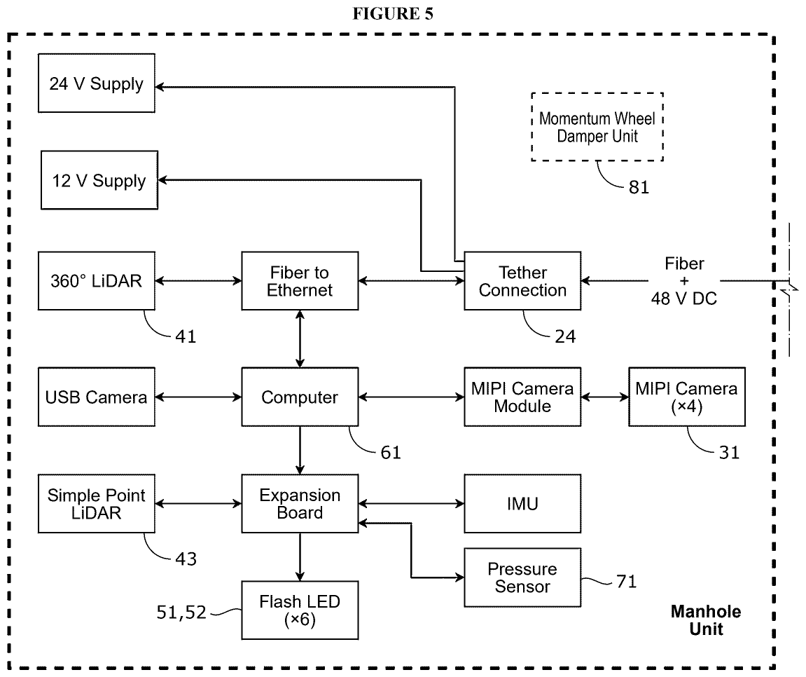

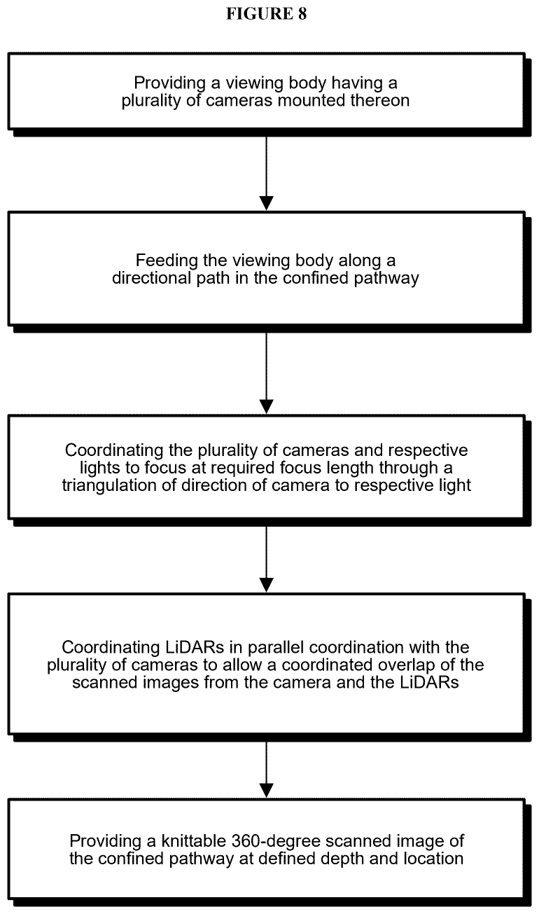

As shown in FIGS. 4, 5, and 8 the viewing body (21) includes a stabilizer (81) for stabilizing the released controlled lengths of tether (25) to stabilize the orientation of the tether and the viewing body. The stabilizer (81) includes a momentum wheel damper unit for damping the vertical torques (or swing) generated on the viewing body due to the pendulum-like nature of the entire unit.

The momentum wheel damper unit includes a flywheel spun up to roughly 3,000+ RPM by a brushless DC motor (BLDC), allowing rotation in the x- and y-plane, by servo motors to impart reaction torques on the body for damping the vertical torques (or swing) generated on the viewing body due to the pendulum-like nature of the entire unit.

These reaction torques can be accurately controlled by an algorithm to assist in canceling and torques (or swing) generated on the viewing body due to the pendulum-like nature of the entire unit.

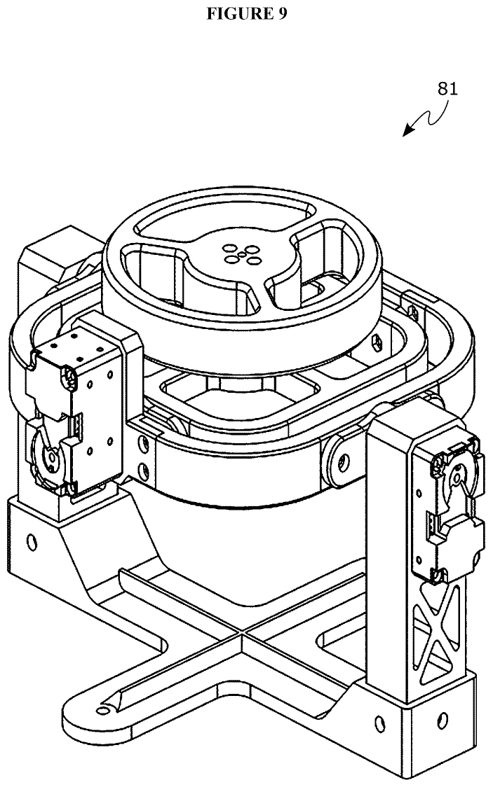

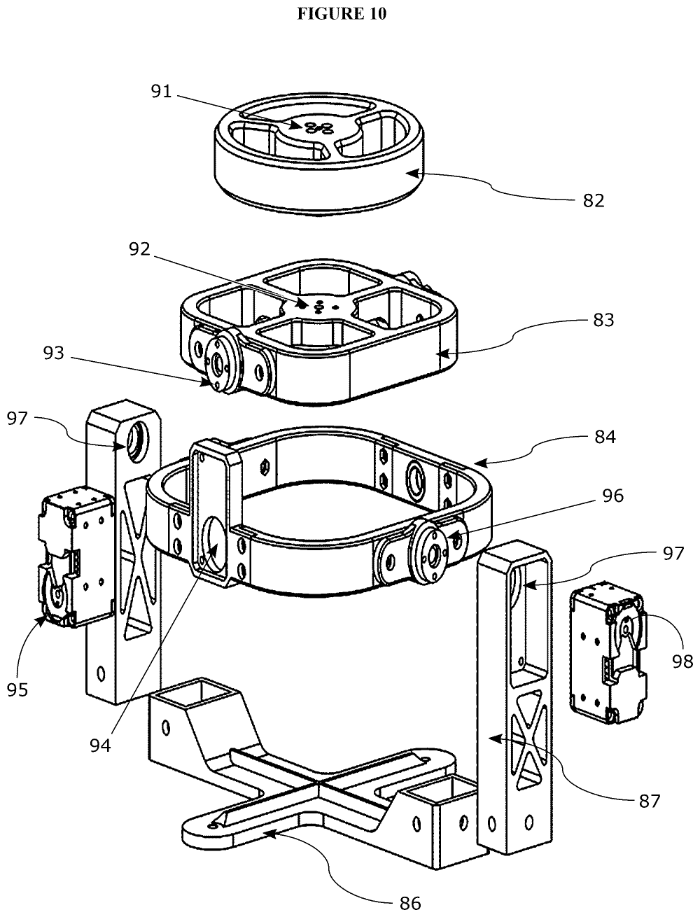

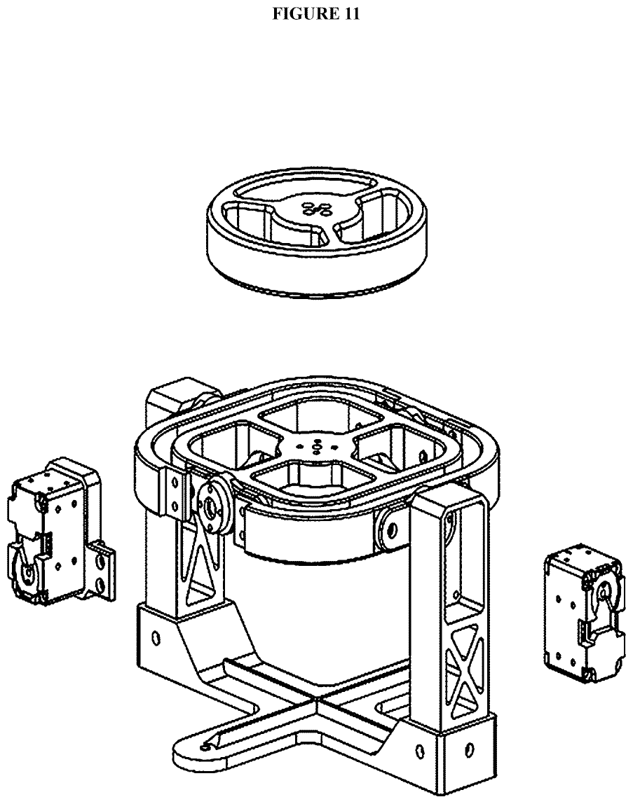

Referring to FIGS. 9, 10, and 11 there is shown a momentum wheel damper unit in the form of a stabilizer (81) uses control moment gyroscope to generate a momentum vector with direction control, in order to offset the angular momentum generated by natural means through the deployment of the visual analyzer down a vertical shaft.

Natural disturbances can be introduced to the system, which cause swing and twist, from means such as wind or human intervention. The control moment gyroscope can be used to counteract these natural disturbances. This is controlled algorithmically and will utilize feedback from the onboard sensors, such as pressure, IMU, cable counter, etc.

The stabilizer (81) comprises a rotating weighted flywheel (82) mounted on a first platform (83) which is pivotally mounted on larger circumventing second platform (84) which is mounted pivotally on arms (87) mounted on base (87) to form a U-shaped frame.

The flywheel is able to spin in a plane parallel to the plane of the first platform, which in one stationary position could be coplanar with the second platform and can be selectively orthogonal to the base but coplanar with the arms of the U-shaped frame.

The flywheel rotation can have a rotational dampening effect in x-y directions and thereby stabilizing the visual analyzer to the vertical tether line. This is achieved by controlling drive and controlling the relative rotation of the first platform to the second platform and to the U-shaped frame.

The interaction of the main components is facilitated by the mounting of the flywheel (82) by central spinning mount (91) on spinning axial spigot (92) located centrally on the top of the first frame (83). This frame is pivotally mounted by first opposing proud rotating mounts (93) fitting within first circular receiving mount openings (94) at corresponding inner sides of the second frame (84). This allows pivoting around the axis between the first receiving mounts (94). The second frame is mounted to the U-shaped frame by second opposing proud rotating mounts (96) fitting within second circular receiving mount openings (97) at corresponding inner sides of the upright spaced arms (97) of the U-shaped frame, second frame (84). This allows pivoting around the axis between the second receiving mounts (97) which is orthogonal to the pivoting around the axis between the first receiving mounts (94). Thereby allowing x-y axial control of the rotational dampening by the flywheel. Drivers (95 and 98) can drive the pivoting rotation.

### Auxiliary Sensors

The automatic visual analyzer (11) can include other sensors which act in synergistic operation. These sensors can be mounted on or in the viewing body (21).

In one form shown in the embodiments is a bottom-facing single point LiDAR acting as an inline LiDAR (43) to provide “range to bottom” data and to allow the operator to know the range to obstacles below the unit or to the bottom of the manhole.

A pressure sensor can be mounted on the viewing body to measure depth from surface of the manhole. This is particularly advantageous in depths of water where pressure from the top surface of the water can be calculated. However, it is also of substantial benefit in deep confined pathways where atmospheric pressure differences are readily detected. Interlacing this sensed pressure with other sensors or scanned images will provide a synergistic substantial increase in accuracy and assist in eliminating discrepancies caused by variable environments at different levels in the confined pathway.

Another sensor used in combination can be an inertial measurement unit, or IMU, used to provide linear acceleration, angular velocity, and heading to magnetic north. This data can be used to help obtain a direction within the manhole, which can be overlaid into the video feeds, providing directional context for the operator.

The IMU also feeds into the control algorithm for the pendulum motion damping of the momentum wheel damper unit. This assists in keeping the viewing body stationary in the x-y plane during descent and prevent rotation that may be imparted on the tether from the surface.

Combination of pressure sensor and single point LiDAR can be used to accurately tag the video feeds/images to the true position within the manhole. When placing into the backend, this data is used to generate a true-to-reality digital replica of the manhole.

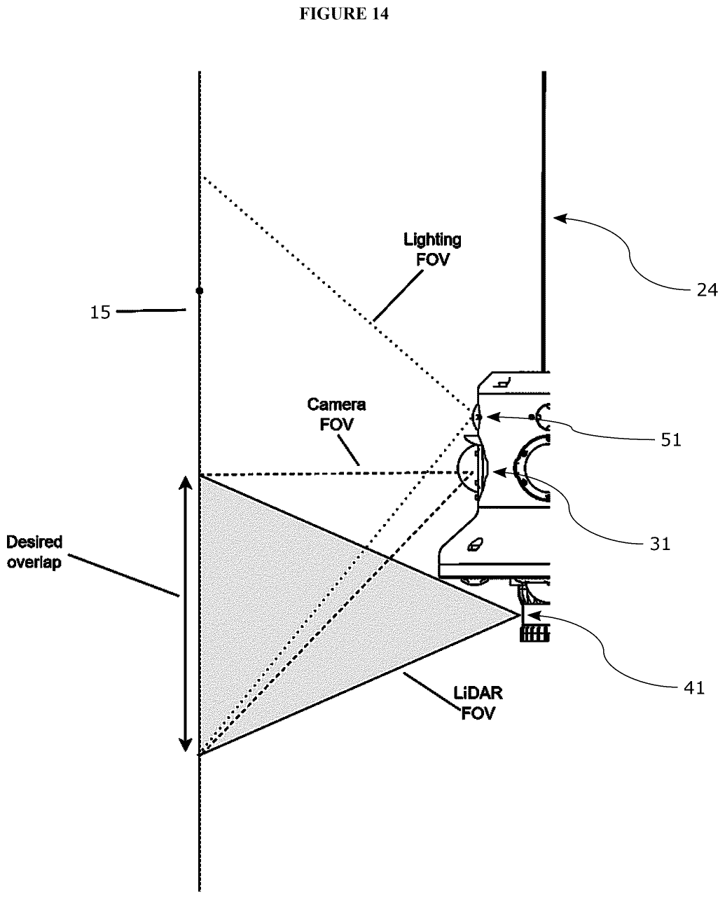

As shown in FIG. 14, the visual analyzer in location in a manhole has consistent spacing of light (51), camera (31), and LiDAR (41) to effect the triangulation field of view (FOV) and focus to allow the 3D imaging and location of image in confined spaces. As the confined spacing in a manhole can be only in the range of 0.5 m to 10 m.

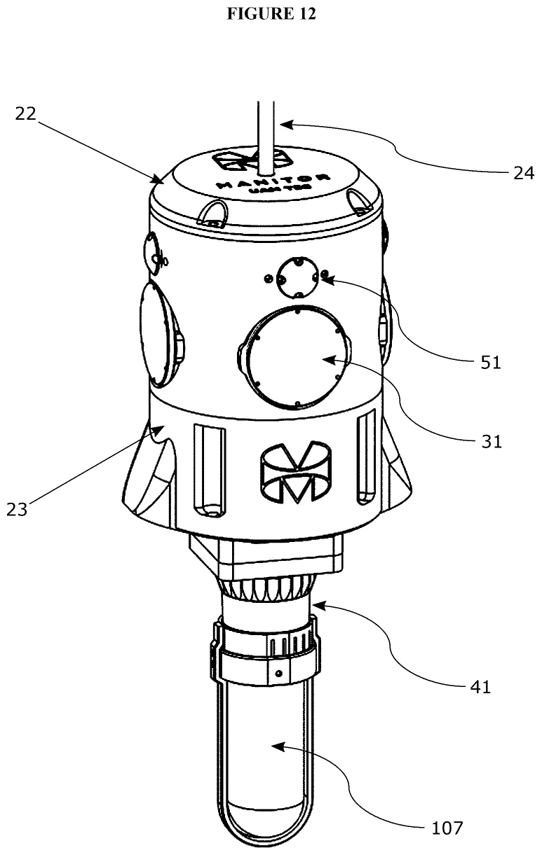

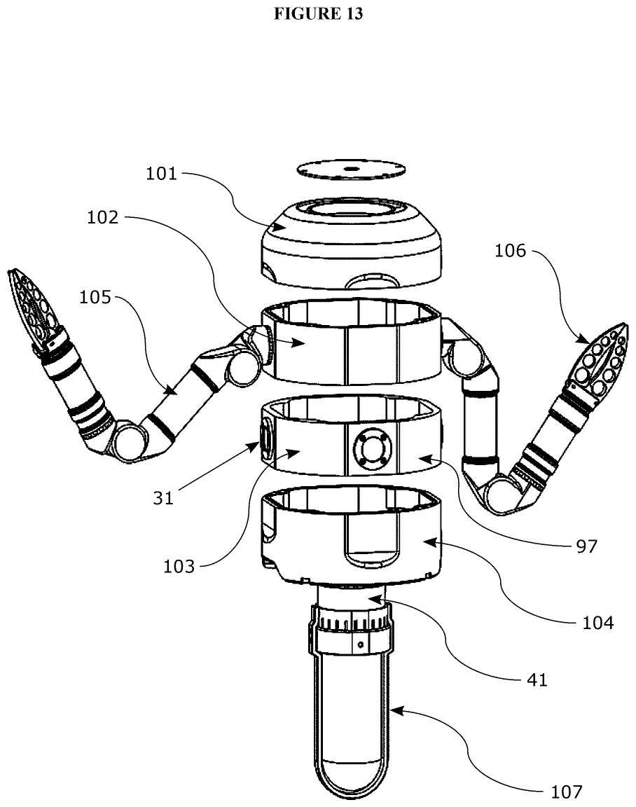

It is important that there are two forms of detection and image analysis. Primarily it is the cameras and the LiDAR at spaced locations and acting at different angles to each other such that a triangulation location and focusing is used and allows analysis. However, other sensors and cameras can be used and mounted on the visual analyzer such as the different form of camera (107) mounted vertically from the below the LiDAR as shown in FIGS. 12 and 13.

### Flexible Form and Shape and Modularity

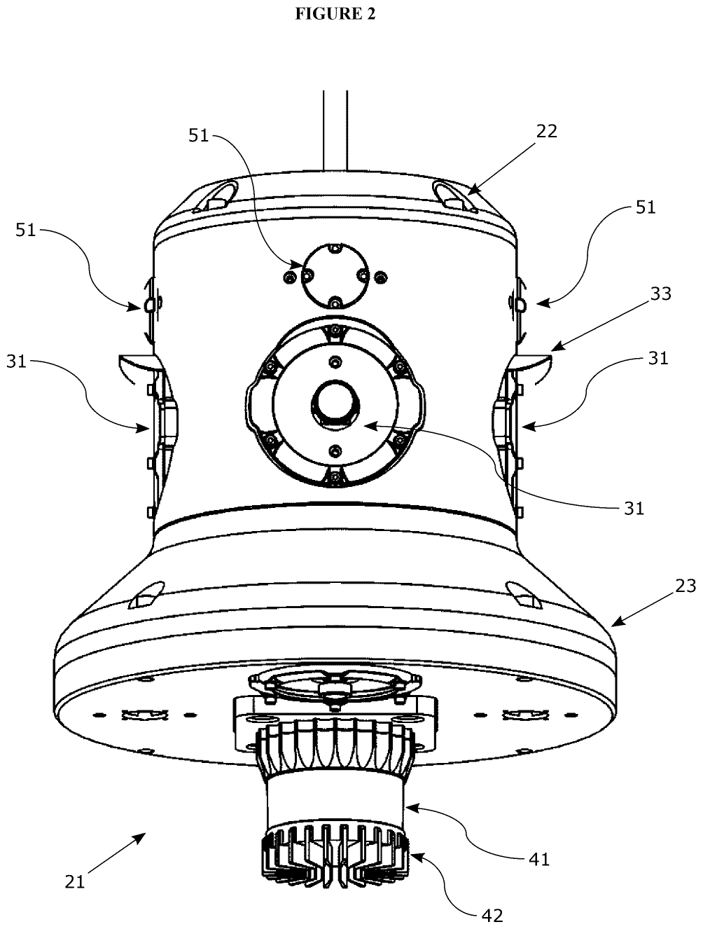

Therefore, as shown in particular in FIGS. 12 and 13 compared to FIGS. 1 to 4, the visual analyzer is not confined to some specific form, in order to achieve function. Cylindrical designs, box designs, spherical designs, would all suffice, as long as the relationship of LIDAR (41) to camera (31) to lighting is maintained.

In the modularity structure one form can have the following:
(a) “Hamburger” style modularity whereby the visual analyzer can be separated into layers, which can be swapped out and modified, with a common interface line going between each layer to allow any configuration desired.
(b) Each module is self-contained, in that it takes a universal power input and communication input and handles internally any voltage regulation (step-up or step-down) and communication interfacing.
(c) This modularity allows for the addition or removal of sensor payloads to cater for different applications.
(d) Daisy chaining of power and communication interface between modules.

Looking at modular comparison of FIGS. 12 and 13, in FIG. 12 there is the barrel (22) including the barrel top, that houses the cameras (31) and lights above (51) and any eyebrows or shading therebetween and is connected to a stabilizing frustoconical barrel skirt (23) carrying other payload but including downward LiDAR (43) and cameras (32) and lights (52) for steering control as the tether (24) is extended. Within this payload can be the momentum wheel damper unit (71). Connected centrally and axially beneath the barrel (52) and barrel skirt (53) is the 360° LiDAR (41) and to which can also be attached other accessories like a further elongated camera (107).

However as shown in FIG. 13 the body housing shaping does not need to have a stabilizing shape as the momentum wheel damper unit can provide the active stabilization. This also allows for protruding working arms (105) and attached working claws (106) to be available for use while maintaining full stabilizing control so as to be able effect the required visual analysis.

Therefore, the body of the visual analyzer of FIG. 13 can be generally cylindrical and include different active elements which are connected in modular form. However as detailed it is important to have the consistent spacing of light (51), camera (31), and LiDAR (41) to effect the triangulation field of view.

In the structure of FIG. 13 there is the hamburger layering of modules of the head or lid module (101) covering the top of the upper torso module (102) from which extends outwardly and controllably working arms (105) and working claws (106). This module connects to the mid torso module (103) that has the set of cameras (31) spaced circumferentially around so as to ensure vision at any one segment of the 360° view. A closing lower torso module (104) which can include other payload and other auxiliar sensors closes the bottom of the substantial cylindrical barrel body. Underneath and connected centrally and axially beneath the barrel (52) and barrel skirt (53) is the 360° LiDAR (41) and to which can also be attached other accessories like a further elongated camera (107). By ensuring that modules are fitted in the right order and have a defined height and are consistently spaced to the LiDAR (41) below, there is consistent and controllable triangulation for effective visual analysis and recording in real time at determinable known fixed positions.

### Live Data Collection/Visualization

Live generation of the manhole through point cloud is achieved with the visual analyzer of the invention and with visual image/video overlay.

Virtual reality (VR) environment allows for manipulation and inspection of the “world” in real time. Tagging and flagging points of interest during a live deployment of the visual analyzer. Live visualization allows operators to focus on points of interest in real time, where the visual analyzer can be stopped to allow focus to be placed on this POI for denser point cloud of higher resolution imagery. This allows an operator to perform an equivalent virtual inspection, as if they had gone in the manhole themselves. Different RGB lighting can be used to enhance visibility of certain features within an environment.

### Interpretation

### Embodiments

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures, or characteristics may be combined in any suitable manner, as would be apparent to one of ordinary skill in the art from this disclosure in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention and form different embodiments as would be understood by those in the art. For example, in the following claims, any of the claimed embodiments can be used in any combination.

### Different Instances of Objects

As used herein, unless otherwise specified the use of the ordinal adjectives “first,” “second,” “third,” etc. to describe a common object, merely indicate that different instances of like objects are being referred to and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures, and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward,” “rearward,” “radially,” “peripherally,” “upwardly,” “downwardly,” and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e., to specify the presence of the stated features but not to preclude the presence or addition of further features in various embodiments of the invention.

Any one of the terms “including” or “which includes” or “that includes” as used herein is also an open term that also means including at least the elements/features that follow the term but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulae given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the for remotely analyzing confined pathways such as sewers and sewer access channels industries.

What is claimed is:

1. An automatic visual analyzer for remotely analyzing confined pathways such as sewers and sewer access channels, the automatic visual analyzer comprising:
a. a viewing body having a plurality of cameras mounted thereon in fixed related directions to allow a defined directional scan of the confined pathway;
b. a drive line for providing a directional path along the confined pathway by which the viewing body can be driven;
c. at least one communication system connected to the body and/or drive line for control communication of the viewing body and communication with the plurality of cameras; and
d. at least one controller for transmitting or receiving communication from the at least one communication system allowing the communication to be transmitted or received external of the confined pathways being analyzed.

2. An automatic visual analyzer according to claim 1 including a LiDAR wherein the LiDAR and the plurality of cameras are at fixed predetermined spacing.

3. An automatic visual analyzer according to claim 2 including a 3D generator for generating a digital representation of the confined pathway by the overlap known directional scans by the plurality of cameras mounted on the viewing body in fixed related directions.

4. An automatic visual analyzer according to claim 1 wherein the confined pathway is substantially in the range of 0.5 meters to 10 meters.

5. An automatic visual analyzer according to claim 1 wherein the drive line is a tether for a vertical gravity driven feed.

6. An automatic visual analyzer according to claim 5 wherein the drive line includes a depth spool for release of controlled lengths of tether to alter the depth of the viewing body on the tether and further includes a depth spool controller for controlling the release of the controlled lengths of tether.

7. An automatic visual analyzer according to claim 1 wherein the drive line includes a stabilizer for stabilizing the released controlled lengths of tether to stabilize the orientation of the tether and the viewing body.

8. An automatic visual analyzer according to claim 7 wherein the stabilizer includes a momentum wheel damper unit for damping the vertical torques (or swing) generated on the viewing body due to the pendulum-like nature of the entire unit.

9. An automatic visual analyzer according to claim 7 wherein the stabilizer includes a momentum wheel damper unit having a flywheel and pivoting first and second mounts allowing selectable orientation in variable x- and y-plane to effect stabilizing rotational dampening relative to that plane.

10. An automatic visual analyzer according to claim 9 wherein the momentum wheel damper unit includes a flywheel spun up to roughly 3,000+ RPM by a brushless DC motor (BLDC), allowing rotation in the x- and y-plane by servo motors to impart reaction torques on the body for damping the vertical torques (or swing) generated on the viewing body due to the pendulum-like nature of the entire unit.

11. An automatic visual analyzer according to claim 1 wherein the plurality of cameras mounted on the viewing body in fixed related directions is mounted coplanar in a direction normal to the directional path of the driveline.

12. An automatic visual analyzer according to claim 11 wherein the number of the plurality of cameras is dependent on the relative location and the coplanar field of view (HFOV) of the lens of the plurality of cameras and wherein the number of the plurality of cameras each have a related light mounted adjacent on the viewing body.

13. (canceled)

14. An automatic visual analyzer according to claim 1 including a plurality of different active elements which are connected in modular form.

15. An automatic visual analyzer according to claim 14 wherein the selection and connection of modules provides a consistent spacing of light, camera, and LiDAR to effect a predefined triangulation field of view.

16. An automatic visual analyzer according to claim 15 wherein the mount of each related light mounted adjacent on the viewing body includes an adjustable means allowing the camera and light to substantially align with the camera line of sight.

17. An automatic visual analyzer according to claim 16 wherein the mount includes an adjustable bracket allowing the camera and light to substantially prealign to intersect the camera's line of sight at the required focus distance in the confined pathway.

18. An automatic visual analyzer according to claim 17 wherein the required focus distance in the confined pathway is the wall of the confined pathway.

19. An automatic visual analyzer according to claim 1 including a combination of a pressure sensor and a single point LiDAR in the directional path of the drive line which can be used to accurately tag the video feeds/images of the plurality of cameras and the true position within the confined pathway.

20. A method of visual analysis of confined pathways such as sewers and sewer access channels, the method including the steps of:
a. providing a viewing body having a plurality of cameras mounted thereon in fixed related directions to allow a defined directional scan of the confined pathway automatic visual analyzer;
b. feeding the viewing body along a directional path in the confined pathway;
c. coordinating the plurality of cameras and respective lights to focus at required focus length through a triangulation of direction of camera to respective light; and
d. coordinating other sensors with the cameras to provide a scanned image of confined pathway at known location.

21. A method of visual analysis of confined pathways according to claim 20 including using LiDARs in parallel coordination with the plurality of cameras to allow a coordinated overlap of the scanned images from the camera and the LiDARs.

22. A method of visual analysis of confined pathways according to claim 21 including using coordinated focus of cameras and respective lighting by a triangulated directional mounting of each camera and its respective light.

23. A method of visual analysis of confined pathways according to claim 21 including providing power to the viewing body having a plurality of cameras by a staged power supply and allowing operation of the viewing body having a plurality of cameras at low voltage.

24. A method of visual analysis of confined pathways according to claim 23 including controlling pendulum sway by a stabilizer for stabilizing the released controlled lengths of tether to stabilize the orientation of the tether and the viewing body.

25. A method of visual analysis of confined pathways according to claim 23 wherein the stabilizer includes a momentum wheel damper unit for damping the vertical torques (or swing) generated on the viewing body due to the pendulum-like nature of the entire unit.

26. An automatic visual analyzer for remotely analyzing confined pathways such as sewers and sewer access channels, the automatic visual analyzer comprising:
a. a viewing body having:
i. a substantially hazard-preventing structure preventing environmental explosion; or
ii. a modular structure for allowing variable configurations; and
iii. a plurality of cameras mounted thereon in fixed related directions to allow a defined directional scan of the confined pathway;
b. a drive line comprising an extendable tether for providing a directional path along a substantially vertical confined pathway by which the viewing body can be driven;
c. a powering system connected to the tether allowing for supply of power in a controlled step-up or step-down configuration;
d. at least one communication system which is:
i. connected to the body and/or drive line for control communication of the viewing body and communication with the plurality of cameras; and
ii. able to transmit and receive communication from the at least one communication system allowing the communication to be transmitted or received external of the confined pathways being analyzed; and
e. an active stabilizer including:
i. a momentum wheel damper unit for damping the vertical torques (or swing) generated on the viewing body due to the pendulum-like nature of the entire unit; and
ii. including pivoting first and second mounts allowing selectable orientation in variable x- and y-plane to effect stabilizing rotational dampening relative to that plane.
